(19) United States
(12) Patent Application Publication
(10) Pub. No.: US 2004/0260538 A1
(43) Pub. Date: Dec. 23, 2004

(54) System and method for voice input to an automation system

(75) Inventor: Carl P. Morse, Milford, NH (US)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Automation Inc.

(21) Appl. No.: 10/465,106

(22) Filed: Jun. 19, 2003

(51) Int. Cl. G10L 19/00

(52) U.S. Cl. 704/201

(57) ABSTRACT

A system for providing voice input to a subcomponent of an automation system. The system comprises an apparatus for receiving vocal transmissions from an operator of the subcomponent and converting the vocal transmissions to an electrical vocal signal. The system further comprises a PLC operatively associated with the subcomponent. The PLC is configured to receive the electrical vocal signal and convert the electrical vocal signal into an input signal associated with operation of the subcomponent.

### RELATED APPLICATIONS

The present application is being filed concurrently with applications for “System And Method For Ocular Input To An Automation System” (Attorney Docket No. SAA-96 (402P312)), serial number unknown at present time; “System And Method For Voice Output From An Automation System” (Attorney Docket No. SAA-97 (402P313)), serial number unknown at present time; and “Biometric PLC Access And Control System And Method” (Attorney Docket No. SAA-98 (402P314)), serial number unknown at present time;, which are incorporated herein by reference. These applications have the same the inventor.

### TECHNICAL FIELD

The present invention is generally related to a hands free system and method for inputting data or controlling an automation system, and more particularly to a system and method for using voice input to facilitate use of a machine or other subcomponent of an automation system.

### BACKGROUND OF THE INVENTION

Programmable logic controllers (PLCs) have been used for many years in factory settings to control the execution of numerous independent tasks of one or more devices or pieces of machinery. Such controllers can be configured to be compact, robust and capable of operating in harsh environments that generally deter using a personal computer (PC). In view of these and other attributes, PLCs are a popular choice for implementation in automation systems that are typically located in the factory settings.

PLCs operate in accordance with a stored control program that causes the controller to examine the state of the equipment under its control by evaluating signals from one or more sensing devices. Additionally, PLCs are typically configured to receive input from a user or operator through an IO module or a human-machine interface (HMI).

There are many instances in the factory setting where a user or operator of a device or machine located in the factory, is required to input certain information or control signals during operation of the device or machine. Moreover, this often occurs in circumstances where it is difficult or impossible for the operator to utilize the traditional input system (e.g., a control panel, keyboard or touch sensitive screen) which may require physically pushing a button or flipping a switch. For example, this situation may occur where an operator is utilizing a portion of a machine remote from the control center of the machine, or is required to hold a part in place during operation of the machine. In such circumstances, it becomes necessary for two operators to be present (one to perform the remote task, and one to provide the required input at the control center) to effectively operate the machine. This increases the production costs, which are either passed to the consumer or result in lower profitability.

### SUMMARY OF THE INVENTION

The present invention provides a hands free system and method for inputting data or control signals into a device or machine. The system and method are preferably implemented in connection with a device or machine which form a part or subcomponent of an automation system. Specifically, the hands free system and method involve utilizing voice input to relay data or control information to the device or machine. This allows an operator of the machine to provide data or control the machine from a location remote from any control system for the machine. The present invention utilizes objects in a PLC process to recognize spoken words as commands and to act on them as defined.

The present invention could be applicable to provide a voice input as a direct input to a PLC operatively associated with a device or machine. Alternatively, the voice input can be provided through an IO module, or a Human Machine Interface connected to the automation system. The invention combines voice input technology, such as that used for input to a computer, with an industrial automation environment for traditional factory applications where an operator's hands would not normally be available for alternate input means (e.g., buttons, levers etc. at a centralized control panel). The voice input technology can be similar to the technology used for facilitating word processing from vocal input. Such technology is believed to have been initially developed for use by those having a handicap or other disability that prevented use of a traditional computer keyboard or mouse.

In one embodiment of the invention, a system for providing voice input to a subcomponent of an automation system comprises an apparatus for receiving vocal transmissions from an operator of the subcomponent and converting the vocal transmissions to an electrical vocal signal and, a PLC operatively associated with the subcomponent. The PLC is configured to receive the electrical vocal signal and convert the electrical vocal signal into an input signal associated with operation of the subcomponent. The input signal may be data useful for the functioning of the subcomponent, or a command to implement or execute an operation by the subcomponent.

The apparatus for receiving vocal transmissions can comprise any type of instrument that can receive and transmit vocal transmissions from an operator of the subcomponent. For example, a headset microphone or telephone type unit can be utilized. The apparatus can be wireless or connected to the PLC through a wire or network connection. Moreover, the apparatus can be part of or externally mounted to one or all of the PLC, or an I/O module or a Human-Machine Interface (HMI) associated with the subcomponent. The apparatus may also comprise a microphone externally mounted proximate (in this case either near or on) a portion of the subcomponent.

A large number of different devices, machines or subcomponents of an automation system can utilize the present invention. Non limiting examples of such subcomponents include a system for obtaining items from a bin, a system for operating holding tanks, and a system for providing access to a component.

In another embodiment of the invention, a system for hands free input into a subcomponent of an automation system comprises an apparatus configured to receive vocal input from an operator of the subcomponent and convert the vocal input into an electric signal, a speech processor operatively accessible to the apparatus, and a PLC operatively accessible to the speech processor, the PLC is configured to control aspects of the subcomponent. The speech processor can be operatively accessible to the apparatus via a wire or network connection, or a wireless connection. Similarly, the PLC can be operatively accessible to the speech processor via a wire or network connection, or a wireless connection. Moreover, the speech processor can be a component or part of the PLC. The electrical signal can be converted into data associated with operation of the subcomponent, or a command for implementing a function of the subcomponent.

In operation, the system is implemented by an operator vocalizing an instruction or command to an apparatus, such as a microphone or telephone type device. The instruction or command is converted to an electrical signal and is transmitted to a speech processor. The speech processor can utilize voice recognition software to convert the electrical signal (i.e., the vocal input of the operator) into a signal (e.g., software code) recognized by the PLC associated with operating a particle machine or device in an automation system. The PLC can then implement the appropriate function desired by the operator. In this regard, the instruction or command can contain data that may be stored by the PLC for later use or comparison.

Another embodiment of the invention provides a method for providing input to a subcomponent of an automation system. The method comprises the steps of receiving a vocal signal related to operation of the subcomponent by an operator and, converting the vocal signal into an input signal associated with operation of the subcomponent. The vocal signal is converted into an input signal by converting the vocal signal into an electrical signal; and, processing the electrical signal into the input signal. A speech processor can be provided for processing the electrical signal into the input signal. The electrical signal is transmitted to the speech processor via a wireless connection, or a wire or network connection.

The input signal can then be transmitted to a PLC associated with operation of the subcomponent. The method can further comprise the steps of implementing a function of the subcomponent in response to the input signal received by the PLC. In the instance where the input signal contains data associated with operation of the subcomponent, the method can instead include storing the data in a memory associated with the PLC.

The method can further include the step of providing a microphone for receiving the vocal signal and converting the vocal signal into an electrical signal. Following this step, the method comprises either wirelessly transmitting the electrical signal to a speech processor for converting the electrical signal to the input signal, or transmitting the electrical signal to the speech processor over a wire or network connection. Similarly, the method can further comprise wirelessly transmitting the input signal to the PLC, or transmitting the input signal to the PLC over a wire or network connection.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a timing chart or diagram illustrating the signal processing sequencing or flow of a system in accordance with the present invention;

FIG. 2 is a diagram of a user utilizing one embodiment of the present invention;

FIG. 3 is a diagram of a user utilizing another embodiment of the present invention; and,

FIG. 4 is a diagram of a user utilizing yet another embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

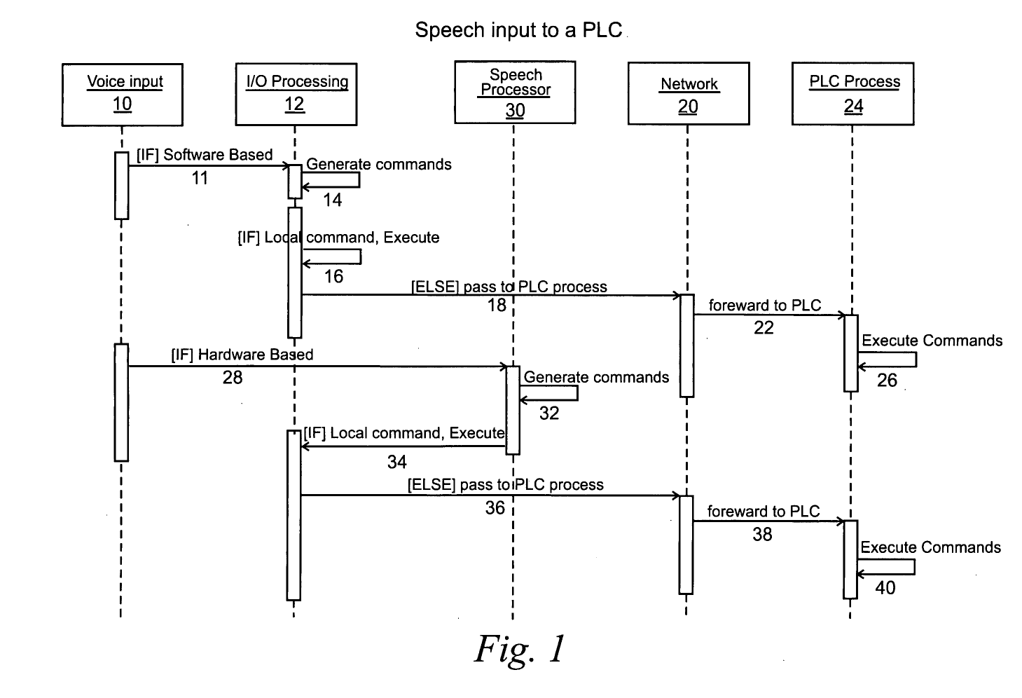

The preferred system of the present invention is utilized in connection with an automation system having a plurality of subcomponents which are controlled or monitored at least in part by programmable logic controllers (PLCs). Additionally, the subcomponents may utilize I/O modules and/or HMIs. FIG. 1 illustrates the processing steps for implementing embodiments of the present invention in a networked automation system.

A subcomponent of an automation system may include one or more machines or devices controlled by a PLC. An operator utilizing the subcomponent is equipped with a voice input apparatus 10 for inputting vocal transmissions. The vocal transmissions or voice input can be, for example, commands for implementing a particular function of a machine or device in the subcomponent or data relating to an operation being performed by the machine or device.

The voice input apparatus is preferably a microphone that can be carried or worn by the operator (e.g., clipped to the operator's shirt, or connected to an earpiece headset). The microphone receives the vocal transmission from the operator and converts the vocal transmission into an electrical signal. However, the voice input apparatus 10 can be part of or externally mounted to one or all of the PLC, an I/O module, or a Human-Machine Interface (HMI) associated with the subcomponent. The apparatus 10 may also comprise a microphone externally mounted proximate (i.e., near or on) a portion of the subcomponent.

In a first embodiment illustrated in the top portion of FIG. 1, the electrical signal of the voice input apparatus 10 is provided 11 to an I/O module 12 capable of processing the electrical signal. That is, the I/O module includes software capable of converting the electrical signal generated from the voice input into a command signal that can be implemented by some portion of the subcomponent associated with the I/O module 12. The voice input apparatus may be configured to provide the electrical signal to the I/O module 12 either through a wireless connection, or over a wire or network connection.

The I/O module 12 converts the electrical signal into the command signal 14. If the command is intended for a local operation, the system will execute the command 16. If the command is not local, the command is passed 18 to a network connection 20 which forwards 22 the command to a PLC 24. The PLC will then execute the command 26.

In the absence of an I/O module having appropriate software for converting the voice input electrical signal into a command signal (e.g., a hardware based I/O module), the electrical signal is transmitted 28 to a separate speech processor 30. This embodiment is illustrated in the lower portion of FIG. 1. The speech processor 30 converts the electrical signal into the command signal 32 and transmits 34 the command signal to the I/O module for execution if the command is local. If the command is not local, the command is passed 36 to the network connection 20 which forwards 38 the command to a PLC 24. The PLC 24 will then execute the command 40.

In one example of the invention shown in FIG. 2, a user 50 desires to obtain an item from a particular location in a bin 52. A voice input apparatus 54 is positioned to allow the user 50 to vocalize the specific position 56 of the desired item in the bin 52. The voice input apparatus 54 is connected to a PLC 58. The PLC 58 is connected to a conveyor system 60 capable of obtaining the specified item. The PLC 58 operates the conveyor system 60 to obtain the item in accordance with the vocal instructions of the user 50.

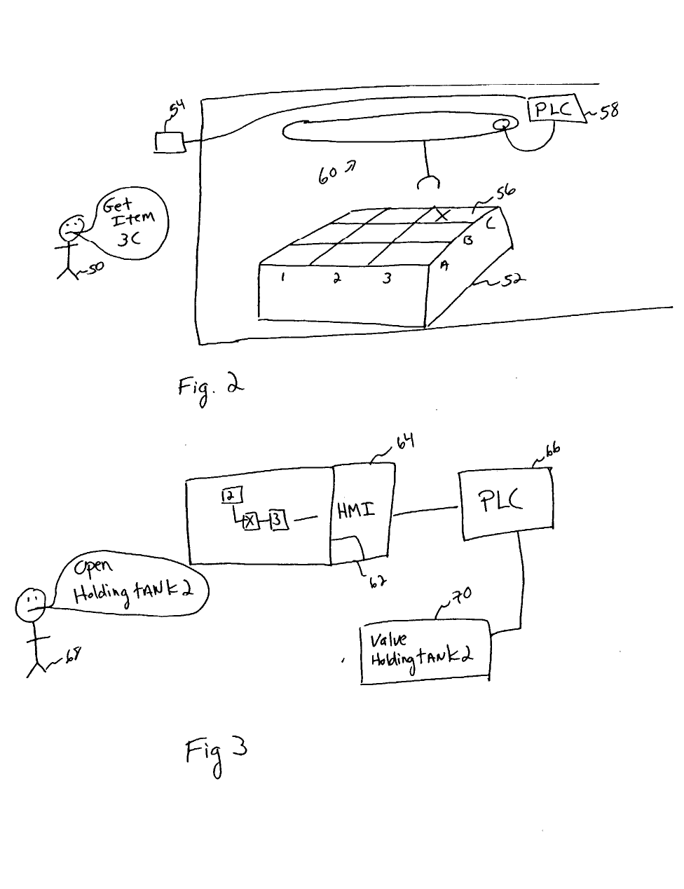

In another example of the invention shown in FIG. 3, a voice input apparatus 62 is part of an HMI 64 for operating a number of holding tanks. The HMI communicates with a PLC 66, which is used to operate functional aspects of the holding tanks. As illustrated in FIG. 3, a user 68 vocalizes a request to open holding tank number 2. The HMI 64 relays this to the PLC 66 which in turn, operates a valve 70 connected to holding tank number 2 to open the holding tank.

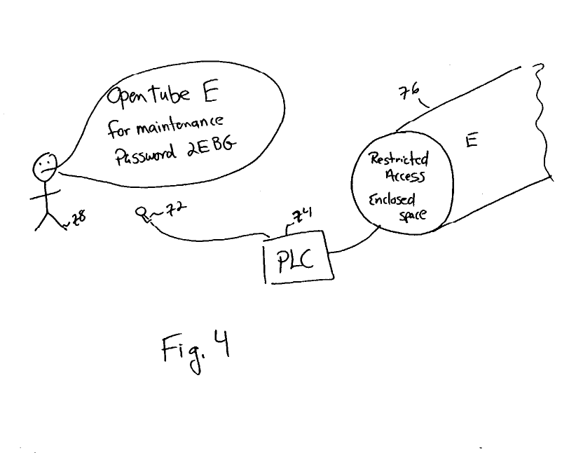

In a further example of the invention shown in FIG. 4, a voice input apparatus 72 is connected to a PLC 74 which operates to provide access to tube 76. In this example, a user 78 vocalizes a command to open tube E for maintenance. In addition to the command, the user 78 also vocalizes a password required for the PLC 74 to implement the command. The PLC 74 opens a door to provide access to the tube 76 upon receipt of the command and password.

It should be emphasized that the above-described embodiments of the present invention, particularly, any “preferred@ embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I Claim:

1. A system for providing voice input to a subcomponent of an automation system comprising:
an apparatus for receiving vocal transmissions from an operator of the subcomponent and converting the vocal transmissions to an electrical vocal signal; and,
a PLC operatively associated with the subcomponent, the PLC configured to receive the electrical vocal signal and convert the electrical vocal signal into an input signal associated with operation of the subcomponent.

2. The system of claim 1, wherein the input signal comprises data relating to functioning of the subcomponent.

3. The system of claim 1, wherein the input signal comprises a command to execute an operation by the subcomponent.

4. The system of claim 1, wherein the apparatus for receiving vocal transmissions comprises a headset microphone.

5. The system of claim 1, wherein the apparatus for receiving vocal transmissions is part of one of a HMI and an IO module associated with the subcomponent.

6. The system of claim 1, wherein the subcomponent comprises a conveyor system.

7. The system of claim 1, wherein the subcomponent comprises an access panel operated by the PLC.

8. The system of claim 1, wherein the apparatus for receiving vocal transmissions comprises a microphone externally mounted proximate the subcomponent.

9. A system for hands free input into a subcomponent of an automation system comprising:
an apparatus configured to receive a vocal input and convert the vocal input into an
a speech processor operatively accessible to the apparatus;
a PLC operatively accessible to the speech processor, the PLC configured to control aspects of the subcomponent.

10. The system of claim 9, wherein the apparatus transmits the electric signal to the speech processor via a wire connection.

11. The system of claim 9, wherein the apparatus transmits the electric signal to the speech processor via a wireless connection.

12. The system of claim 9, wherein the speech processor converts the electric signal into data associated with operation of the subcomponent.

13. The system of claim 9, wherein the speech processor converts the electric signal into a command for implementing a function of the subcomponent.

14. The system of claim 9, further comprising a network connection configured to allow transmissions from the speech processor to the PLC.

15. The system of claim 9, wherein the apparatus comprises a headset microphone.

16. The system of claim 9, wherein the apparatus is part of one of an HMI and an IO module associated with the subcomponent.

17. The system of claim 9, wherein the subcomponent comprises a conveyor system.

18. The system of claim 9, wherein the subcomponent comprises an access panel operated by the PLC.

19. The system of claim 9, wherein the apparatus comprises a microphone externally mounted proximate the subcomponent.

20. A method for providing input to a subcomponent of an automation system comprising the steps of:
receiving a vocal signal related to operation of the subcomponent; and,
converting the vocal signal into an input signal associated with operation of the subcomponent.

21. The method of claim 20, wherein the step of converting the vocal signal into an input signal comprises the steps of:
converting the vocal signal into an electrical signal; and,
processing the electrical signal into the input signal.

22. The method of claim 21, further comprising the steps of:
providing a speech processor for processing the electrical signal into the input signal; and,
transmitting the electrical signal to the speech processor.

23. The method of claim 20, further comprising the step of:
transmitting the input signal to a PLC associated with operation of the subcomponent.

24. The method of claim 23, further comprising the step of:
implementing a function of the subcomponent in response to the input signal received by the PLC.

25. The method of claim 23, wherein the input signal contains data associated with operation of the subcomponent.

26. The method of claim 25, further comprising the step of:
storing the data in a memory associated with the PLC.

27. The method of claim 21, further comprising the step of:
providing a microphone for receiving the vocal signal and converting the vocal signal into an electrical signal.

28. The method of claim 27, further comprising the step of:
wirelessly transmitting the electrical signal to a speech processor for converting the electrical signal to the input signal.

29. The method of claim 27, further comprising the step of:
transmitting the electrical signal to a speech processor for converting the electrical signal into the input signal over a network connection.

30. The method of claim 23, further comprising the step of:
transmitting the input signal to the PLC over a network connection.
